(19) United States
(12) Patent Application Publication
(10) Pub. No.: US 2005/0157932 A1
(43) Pub. Date: Jul. 21, 2005

(54) Apparatus for and method of graphic processing and computer-readable program

(75) Inventor: Toshiyuki Yamasaki, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 10/998,557

(22) Filed: Nov. 30, 2004

(30) Foreign Application Priority Data
Jan. 15, 2004 (JP) JP2004-008058

(51) Int. Cl. G06K 9/48; G06K 9/00; G06K 9/62; G06K 9/74; G06K 9/36; G06T 11/00; G09G 5/00

(52) U.S. Cl. 382/199; 382/144; 382/143; 382/209; 382/212; 382/283; 345/470; 345/626

(57) ABSTRACT

A graphic processing apparatus sets a circumscribing region circumscribing a developed drawing of a target graphic object and an outer region containing the circumscribing region, and defines the outer region as a selection region. Subsequently, the graphic processing apparatus selects at least one of a plurality of developed drawings which is present in the selection region as an adjacent graphic object. Then, the adjacent graphic object is displayed, and the target graphic object is editably displayed. This enables an operator to easily recognize whether or not interference is occurring between the target and adjacent graphic objects, thereby achieving the efficient operation of editing the target graphic object.

### BACKGROUND OF THE INVENTION

1. Field of the Invention

The present invention relates to a graphic processing apparatus, a graphic processing method and a program for creating layout data including a plurality of graphic objects with design data added thereto, based on graphic information data about the arrangement of the plurality of graphic objects. More particularly, the present invention relates to an improvement for efficiently editing a target graphic object.

2. Description of the Background Art

A method of laying out a plurality of developed drawings (or developments) of paper containers (or containers made of paper for storage and packaging of commodity products) within a predetermined area by the use of CAD capabilities has been conventionally known.

The paper containers are completed by the following steps of: printing the plurality of developed drawings laid out by a conventional method on a predetermined printing material such as a sheet of paperboard or corrugated paper; cutting out the individual developed drawings printed on the printing material by using a cutting machine; and individually building the paper containers from the developed drawings. Thus, the plurality of paper containers are obtained from the single sheet of printing material.

A design including characters, graphics and the like is put on the surfaces of the paper containers to indicate information about the contents of commodity products to be stored in the paper containers or to indicate the producer, seller and the like of the commodity products. To this end, after the plurality of developed drawings of the paper containers are laid out within the predetermined area by the conventional method, the above-mentioned design is put on the developed drawings.

The area size of the design to be put on each developed drawing is defined to be greater than the area size of each developed drawing or to extend off the area of each developed drawing in consideration for the offset of lines along which the cutting machine makes a cut.

The conventional process for putting the design on each of the plurality of developed drawings includes creating a mask containing each of the developed drawings, and inserting the design into the inside region of the mask to superimpose design data on each of the developed drawings.

For the purpose of obtaining as many paper containers as possible from a single sheet of printing material, adjacent developed drawings are arranged in close proximity to or in partial contact with each other. Thus, there arises cases in which a mask region corresponding to a particular developed drawing contains or overlaps a portion of its adjacent developed drawing. This results in a problem such that the design to be put on the particular developed drawing is put also on its adjacent developed drawing. For proper placement of the design on each developed drawing, it is necessary to edit and correct the mask region so as to prevent the inside region of the mask corresponding to a developed drawing of interest from containing a portion of its adjacent developed drawing where it is not desired to put designs for other developed drawings (e.g., a portion of its adjacent developed drawing where a trade name, graphics and the like are to be put).

However, conventional graphic processing apparatuses are capable of the operation of editing the mask only in an “editable mode” in which a selected developed drawing and its corresponding mask are displayed on a display screen. Additionally, the conventional graphic processing apparatuses enable an operator to check to see whether the selected developed drawing and the corresponding mask (referred to as a target graphic object) interfere with its adjacent developed drawing (referred to as an adjacent graphic object) only in an “overall display mode” in which all of the plurality of developed drawings are displayed. As a result, the mask correction requires the operation of switching between the “editable mode” and the “overall display mode” to present the problem of lowered operating efficiency.

### SUMMARY OF THE INVENTION

The present invention is intended for a graphic processing apparatus for processing graphic information data about a plurality of graphic objects arranged within a planar area, each of the plurality of graphic objects including a graphic portion composed of a plurality of graphic primitives.

According to the present invention, the graphic processing apparatus comprises: a first obtaining element for obtaining a target graphic object selected from among the plurality of graphic objects; a second obtaining element for obtaining an adjacent graphic object positioned adjacent to the target graphic object; a display element for displaying the target graphic object together with the adjacent graphic object while maintaining a positional relationship between the target graphic object and the adjacent graphic object, based on the target graphic object; and an editing element for editing the target graphic object, based on an instruction given by an operator, with both the target graphic object and the adjacent graphic object displayed on the display element.

The graphic processing apparatus achieves the efficient operation of editing the graphic portion and a mask portion of the graphic object to improve the throughput of the editing operation.

Preferably, the editing element includes an element for correcting the planar area of a mask portion, the mask portion being formed as an expanded area of the graphic portion of the target graphic object, the mask portion defining an area where design data is put on the target graphic object.

The graphic processing apparatus enables an operator to perform the editing operation while viewing whether or not interference is occurring between the target and adjacent graphic objects, thereby improving the throughput of the editing operation.

Preferably, the second obtaining element selects as the adjacent graphic object a graphic object lying in each of four positions adjacent to a rectangle contacted internally by the graphic portion of the target graphic object among the plurality of graphic objects.

Each of the graphic objects lying in the four positions adjacent to the rectangle contacted internally by the graphic portion of the target graphic object, that is, each of the graphic objects positioned over, under, to the left of and to the right of the rectangle is easily obtained as the adjacent graphic object.

The present invention is also intended for a method of performing a graphic process on graphic information data about a plurality of graphic objects arranged within a planar area, each of the plurality of graphic objects including a graphic portion composed of a plurality of graphic primitives.

According to the present invention, the method comprises the steps of: (a) obtaining a target graphic object selected from among the plurality of graphic objects; (b) obtaining an adjacent graphic object positioned adjacent to the target graphic object; (c) displaying the target graphic object together with the adjacent graphic object while maintaining a positional relationship between the target graphic object and the adjacent graphic object, based on the target graphic object; and (d) editing the target graphic object, wherein the step (d) includes the step of editing the target graphic object, based on an instruction given by an operator, with both the target graphic object and the adjacent graphic object displayed on a display element.

The method achieves the efficient operation of editing the graphic portion and a mask portion of the graphic object to improve the throughput of the editing operation.

The present invention is also intended for a computer-readable program for processing graphic information data about a plurality of graphic objects arranged within a planar area, each of the plurality of graphic objects including a graphic portion composed of a plurality of graphic primitives.

According to the present invention, the program is read by a computer to cause the computer to perform the steps of: (a) inputting a target graphic object selected from among the plurality of graphic objects to store the target graphic object in a storage element of the computer; (b) inputting an adjacent graphic object positioned adjacent to the target graphic object to store the adjacent graphic object in the storage element of the computer; (c) displaying the target graphic object together with the adjacent graphic object on a display element while maintaining a positional relationship between the target graphic object and the adjacent graphic object, based on the target graphic object by a computation element of the computer; and (d) editing the target graphic object stored in the storage element in response to a manipulation of an operator, wherein the step (d) includes the step of editing the target graphic object based on an instruction given by the operator, with both the target graphic object and the adjacent graphic object displayed on the display element.

The program achieves the efficient operation of editing the graphic portion and a mask portion of the graphic object to improve the throughput of the editing operation.

It is therefore an object of the present invention to provide an apparatus for and method of graphic processing and a computer-readable program, which enable an operator to perform the operation of editing a target graphic object selected from among a plurality of graphic objects while viewing whether or not interference is occurring between the target graphic object and its adjacent graphic object.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an example of the construction of a graphic processing system according to first and second preferred embodiments of the present invention;

FIG. 2 is a diagram showing an example of the hardware construction of a graphic processing apparatus according to the first and second preferred embodiments of the present invention;

FIG. 3 illustrates an example of graphic processing executed in the graphic processing apparatus;

FIG. 4 shows an example of a design;

FIG. 5 illustrates the interference of adjacent graphic objects;

FIG. 6 is a flow chart showing a procedure for the process of simultaneously displaying a target graphic object and its adjacent graphic object according to the first preferred embodiment of the present invention;

FIG. 7 illustrates an example of a method of obtaining the adjacent graphic object according to the first preferred embodiment of the present invention;

FIG. 8 shows an example of display of the target graphic object and its adjacent graphic objects according to the first preferred embodiment of the present invention;

FIG. 9 shows an example of display of the target graphic object according to the first preferred embodiment of the present invention;

FIG. 10 shows an example of display of the target graphic object and its adjacent graphic objects according to the first preferred embodiment of the present invention;

FIG. 11 is a flow chart showing a procedure for the process of simultaneously displaying the target graphic object and its adjacent graphic object according to the second preferred embodiment of the present invention;

FIG. 12 illustrates an example of the method of obtaining the adjacent graphic object according to the second preferred embodiment of the present invention;

FIG. 13 shows an example of display of the target graphic object and its adjacent graphic objects according to the second preferred embodiment of the present invention; and

FIG. 14 illustrates another example of the method of obtaining the adjacent graphic object.

### DESCRIPTION OF THE PREFERRED EMBODIMENTS

Preferred embodiments according to the present invention will now be described in detail with reference to the drawings.

### 1. First Preferred Embodiment

### 1.1. Construction of Graphic Processing System

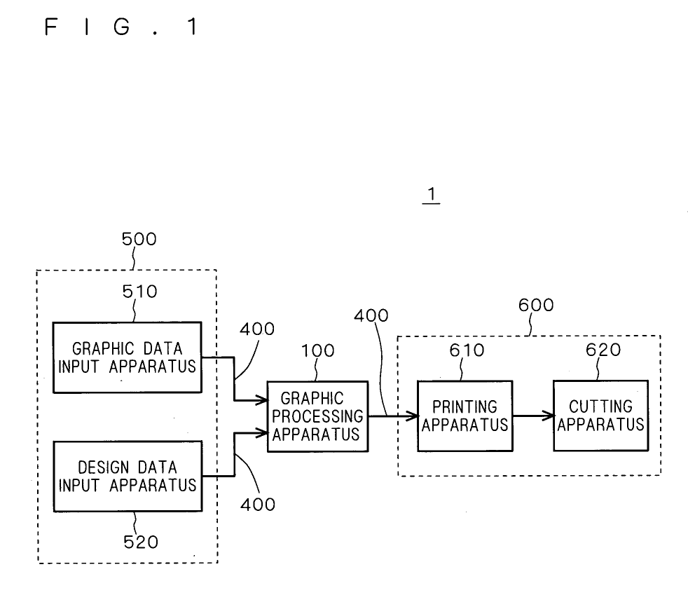

FIG. 1 is a diagram showing an example of the construction of a graphic processing system 1 according to a first preferred embodiment of the present invention. As shown in FIG. 1, the graphic processing system 1 principally comprises: a graphic processing apparatus 100; an input apparatus group 500 including a graphic data input apparatus 510 and a design data input apparatus 520 for providing input data to the graphic processing apparatus 100; an output apparatus group 600 including a printing apparatus 610 and a cutting apparatus 620 for outputting a result of processing of the graphic processing apparatus 100; and a network 400 for connecting the apparatuses 100, 510, 520, 610 and 620 together.

An operator of the graphic processing apparatus 100 places various images and graphic primitives (e.g., lines and curves) within a desired planar area while viewing a screen thereof, whereby the graphic processing apparatus 100 creates page layout data specifying the positions of images and graphic primitives to be printed on a printing material (e.g., paper and plates).

The graphic processing apparatus 100 described in the first preferred embodiment creates the page layout data about a plurality of developed drawings (or developments) of paper containers arranged within a printing area of a plate, the paper containers being made of paper for storage and packaging of commodity products. The present invention, however, is not limited to this. For example, the graphic processing apparatus 100 may create page layout data about a single target graphic object (e.g., a single developed drawing) placed within the printing area of the plate. The details of the hardware construction of the graphic processing apparatus 100 and the graphic processing in the graphic processing apparatus 100 will be described later.

The graphic data input apparatus 510 and the design data input apparatus 520 which constitute the input apparatus group 500 create respective input data for placement on a plate in the graphic processing apparatus 100, and send the respective input data through the network 400 to the graphic processing apparatus 100.

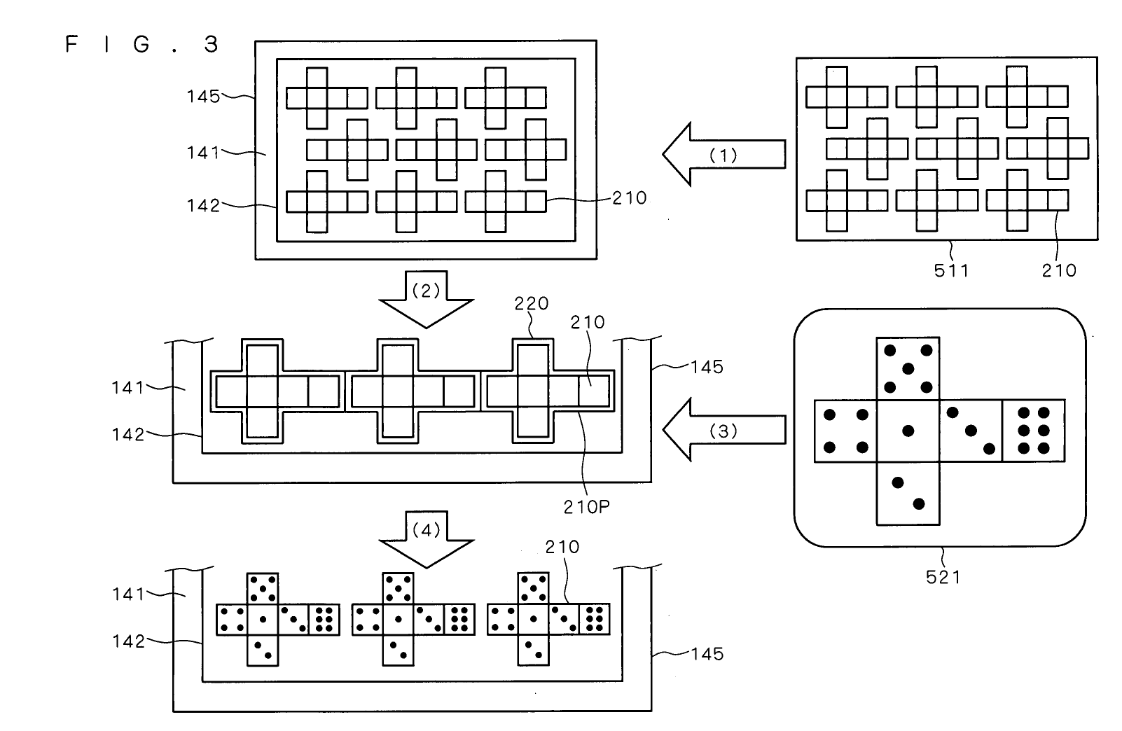

The graphic data input apparatus 510 is an apparatus for creating CAD data 511 (see FIG. 3) about a plurality of developed drawings of paper containers arranged, and is implemented by a personal computer or a workstation. Each of the developed drawings 210 created in the graphic data input apparatus 510 includes a plurality of line segments as graphic primitives. Each of the line segments constituting the developed drawing 210 has positional information about its starting point and its ending point. That is, each line segment as a graphic primitive can be identified using the positional information about its starting point and its ending point as a pair of graphic data. The CAD data created in the graphic data input apparatus 510 is inputted through the network 400 to the graphic processing apparatus 100. Thus, the CAD data are used as graphic information data.

The design data input apparatus 520 is an apparatus for making designs including patterns, colors and the like to be put on the developed drawings 210 of the paper containers. Like the graphic data input apparatus 510, the design data input apparatus 520 is implemented by a personal computer or a workstation.

Painting software for manipulating and correcting graphics represented as a collection of points (e.g., dots or pixels), and drawing software for manipulating and correcting graphics created using lines are installed on the design data input apparatus 520. This enables the design data input apparatus 520 to create various design data. The design data created in the design data input apparatus 520 is inputted through the network 400 to the graphic processing apparatus 100.

The output apparatus group 600 includes the printing apparatus 610 for printing the plurality of developed drawings on a printing material (e.g., corrugated paper and paperboards) by using a plate made based on the page layout data created in the graphic processing apparatus 100, and the cutting apparatus 620 for cutting out the individual developed drawings printed on the printing material. Depending on the apparatus construction, the printing apparatus 610 may perform direct printing on the printing material based on the page layout data without using the plate.

### 1.2. Construction of Graphic Processing Apparatus

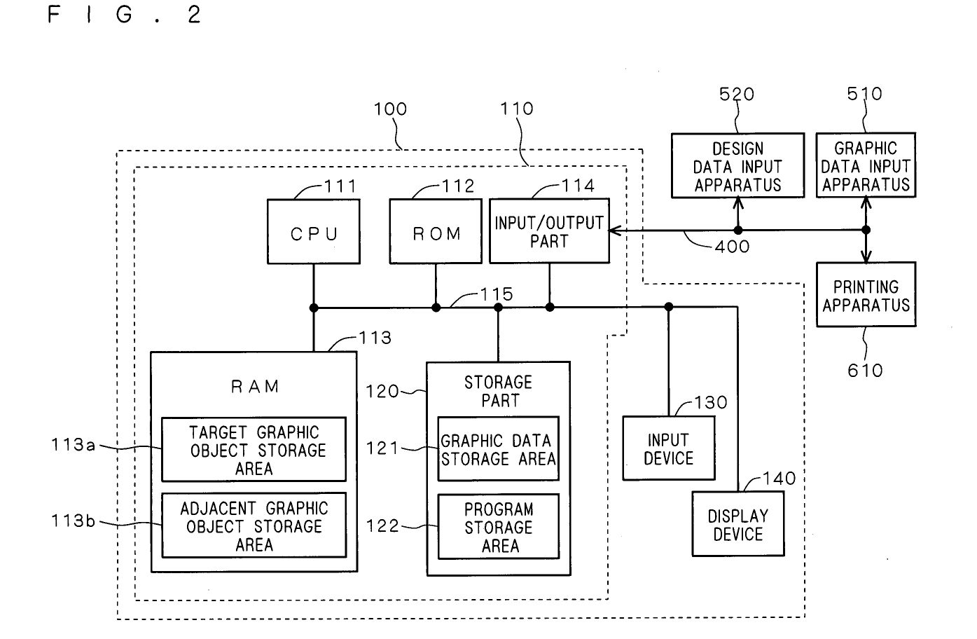

FIG. 2 is a diagram showing an example of the hardware construction of the graphic processing apparatus 100. As mentioned above, the graphic processing apparatus 100 is an apparatus for creating the page layout data specifying the positions of images and graphic primitives to be printed on the printing material. Like the graphic data input apparatus 510 and the design data input apparatus 520, the graphic processing apparatus 100 is implemented by a personal computer or a workstation. As shown in FIG. 2, the graphic processing apparatus 100 principally comprises: a controller 110; an input device 130 for inputting instructions given by the operator of the graphic processing apparatus 100; and a display device 140 for displaying the CAD data and the design data and for displaying results of graphic processing.

The input device 130 includes a mouse, a keyboard, and the like (not shown). The operator performs manipulations in accordance with descriptions or information displayed on a display screen 145 (see FIG. 3) of the display device 140 by the use of the mouse and the keyboard to execute a predetermined process on the graphic processing apparatus 100.

The controller 110 principally comprises a CPU 111, a ROM 112, a RAM 113, a storage part 120, and an input/output part 114 for performing the process of transferring and receiving data to and from the graphic data input apparatus 510, the design data input apparatus 520 and the printing apparatus 610. As shown in FIG. 2, the CPU 111, the ROM 112, the RAM 113, the storage part 120 and the input/output part 114 are electrically connected to each other through a bus line 115. The input device 130 and the display device 140 are also electrically connected to the bus line 115.

The RAM 113 is a device capable of transferring and receiving data faster than the storage part 120 to and from the CPU 111. The RAM 113 reads programs and data required to be executed in the CPU 111 from a program storage area 122 and a graphic data storage area 121 of the storage part 120 to store the programs and data therein. In this preferred embodiment, the RAM 113 includes a target graphic object storage area 113a and an adjacent graphic object storage area 113b reserved for use in the process of simultaneously displaying a target graphic object and an adjacent graphic object to be described later.

The storage part 120 is a mass storage device including an external device such as a silicon disk drive or a hard disk drive, and is capable of storing large-sized data. The storage part 120 transfers and receives data to and from the RAM 113, as required. The graphic data storage area 121 of the storage part 120 in this preferred embodiment stores therein the CAD data 511 (see FIG. 3) and design data 521 to be inputted through the input/output part 114 to the controller 110 of the graphic processing apparatus 100. The graphic data storage area 121 also stores therein information about masks (see FIG. 3) created in a mask creation process to be described later.

The CPU 111 is capable of executing the processes of reading and writing (or transferring) data between the RAM 113 and the storage part 120 in predetermined timed relation in accordance with programs stored in the ROM 112 and the RAM 113. Additionally, the CPU 111 is capable of executing the processes of transferring and receiving the CAD data 511, the design data 521 and the page layout data in predetermined timed relation to and from the graphic data input apparatus 510, the design data input apparatus 520 and the printing apparatus 610 electrically connected thereto through the input/output part 114 and the network 400.

An example of graphic processing executed in this preferred embodiment will be described. FIG. 3 illustrates an example of the graphic processing executed in the graphic processing apparatus 100. As shown in FIG. 3, the graphic processing apparatus 100 principally executes the process of superimposing the design data 521 on each of the developed drawings 210 in steps (1) to (4). Each of the developed drawings 210 is a developed drawing of a cube made up of six squares, as shown in FIG. 3.

In the step (1), the CAD data about the plurality of developed drawings 210 of paper containers created by the graphic data input apparatus 510 is read from the graphic data storage area 121 of the storage part 120 into the RAM 113. Then, the CAD data 511 is inserted into a printable region 142 included in a region (referred to hereinafter as a “plate region”) 141 indicating the plate, and is displayed on the display screen 145.

In the step (2), a mask required in a mask process is created in accordance with a manipulation performed by the operator. The term “mask process” used herein refers to the process of defining a region located within a mask in the printable region 142 as a target region to be subjected to the graphic processing so that the remaining region is not influenced by the graphic processing. The term “mask” used herein refers to a boundary between the region to be subjected to the graphic processing and the regions not to be subjected to the graphic processing. The mask can define the area to which the design data is provided. When a specific mask is designated, the predetermined graphic processing is performed only on the region defined within the mask.

A mask 220 in this preferred embodiment is created around each of the plurality of developed drawings 210 displayed in the printable region 142, and has a shape substantially geometrically similar to the contour of each developed drawing 210. That is, the mask 220 is formed in an expanded area of each developed drawing 210. The area of the mask 220 corresponding to a combination of the area of each developed drawing 210 and a strip-shaped area 210P surrounding the outside of each developed drawing 210. Either a combination of each developed drawing 210 (or a graphic portion) and its corresponding mask 220 (or a mask portion) or each developed drawing 210 alone is referred to as a “graphic object” in this preferred embodiment.

In the step (3), the design data 521 created by the design data input apparatus 520 is read from the graphic data storage area 121 of the storage part 120 into the RAM 113.

When a design is put only on the inside regions of the developed drawings 210, it is conceivable that cutting out the individual developed drawings 210 printed on the printing material by the cutting apparatus 620 along lines offset outwardly from an outline 214 on the outer perimeter of the developed drawings 210 will result in the occurrence of a portion containing no design in the developed drawings 210 after the cutting.

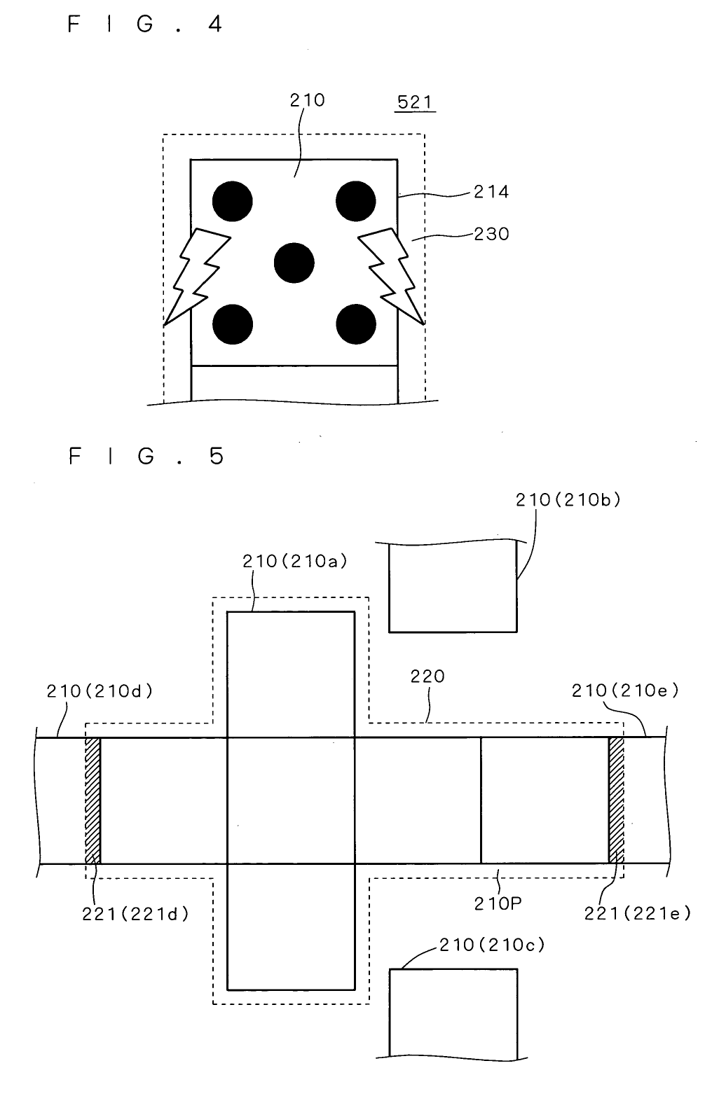

In this preferred embodiment, the design is put also on a surrounding region 230 outside the outline 214 on the outer perimeter of each developed drawing 210 as shown in FIG. 4 in order that the design will be put on the entire regions in the developed drawings 210 after the cutting even if the developed drawings 210 are cut out along the lines offset outwardly from the outline 214 of the developed drawings 210. In other words, the design data 521 contains the design wider in area than each developed drawing 210 around each developed drawing 210.

In the step (4), the design data 521 is inserted into the masks 220 corresponding to the respective developed drawings 210, and is superimposed on each of the developed drawings 210. Specifically, each mask 220 is selected, and the design data 521 is inserted in only the inside of the selected mask. With attention to the orientation of each developed drawing 210, the design data is inverted, mirror-reversed or rotated through a predetermined angle about a predetermined position before the insertion in this step.

This allows the design to be put on only some of the developed drawings 210 subjected to the process of superimposing the design data 521 thereon even if the area in which the design is put in terms of the design data 521 is greater than the area of each developed drawing 210, thereby preventing the influence on other developed drawings 210.

Then, the designs are put on all of the developed drawings 210 by executing the process of superimposing the design data 521 on all of the developed drawings 210.

### 1.3. Simultaneous Display of Target Graphic Object and Adjacent Graphic Object

As discussed above, the process of superimposing the design data 521 on each developed drawing 210 is executed by inserting the design data 521 into the mask 220 created around each developed drawing 210.

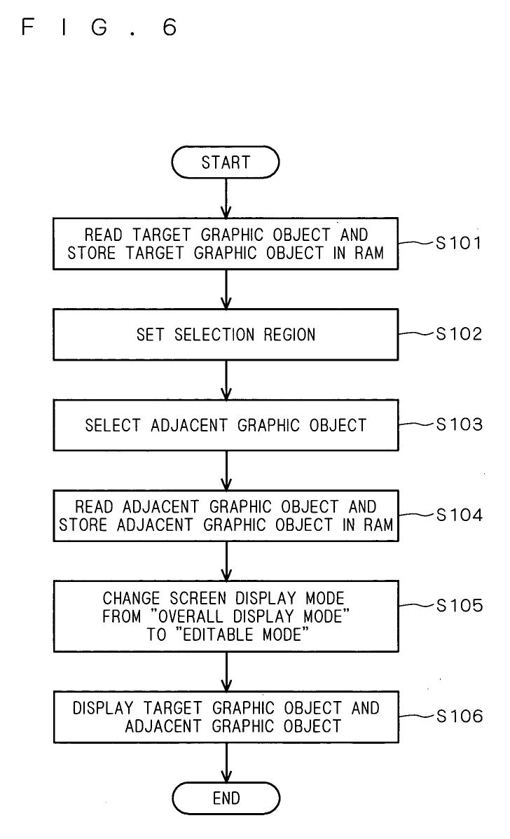

As shown in FIG. 3, the CAD data 511 includes developed drawings 210 adjacent to each other which are arranged in close proximity to or, in some cases, in partial contact with each other for the purpose of obtaining as many paper containers as possible from the single printing material (e.g., paperboard or corrugated paper). Thus, there arise cases where portions 221d and 221e of respective developed drawings 210d and 210e adjacent to a developed drawing 210a are present within or overlap the inside region of the mask 220 corresponding to the developed drawing 210a, as shown in FIG. 5. This results in a problem such that a design to be put on the developed drawing 210a is put also on the portions 221d and 221e of the respective developed drawings 210d and 210e adjacent to the developed drawing 210a.

To properly put designs on the developed drawings 210a, 210d and 210e, it is necessary to edit and correct the mask 220 so that the portions 221d and 221e of the respective developed drawings 210d and 210e adjacent to the developed drawing 210a where the design for the developed drawing 210a is not desired to be put (e.g., a portion of the developed drawing 210d where a trade name, graphics and the like are put) do not overlap the inside region of the mask 220 corresponding to the developed drawing 210a. That is, the process of correcting the planar area of the mask 220 is required.

This preferred embodiment produces simultaneous display of both a target graphic object and its adjacent graphic object for the purpose of efficiently editing and correcting the mask 220 created around and corresponding to the developed drawing 210a.

A combination of the single developed drawing 210a selected by the operator from among the plurality of developed drawings 210 and the mask 220 corresponding thereto is referred to as the target graphic object. Each developed drawing 210b to 210i adjacent to the target graphic object is referred to as the adjacent graphic object.

A program for executing the process (also referred to hereinafter as a simultaneous display process) of simultaneously displaying the target graphic object and the adjacent graphic object to be described below is previously stored in the program storage area 122 (see FIG. 2) of the storage part 120. This program is copied from the storage part 120 to the RAM 113 at the time of execution thereof, and is executed by the CPU 111.

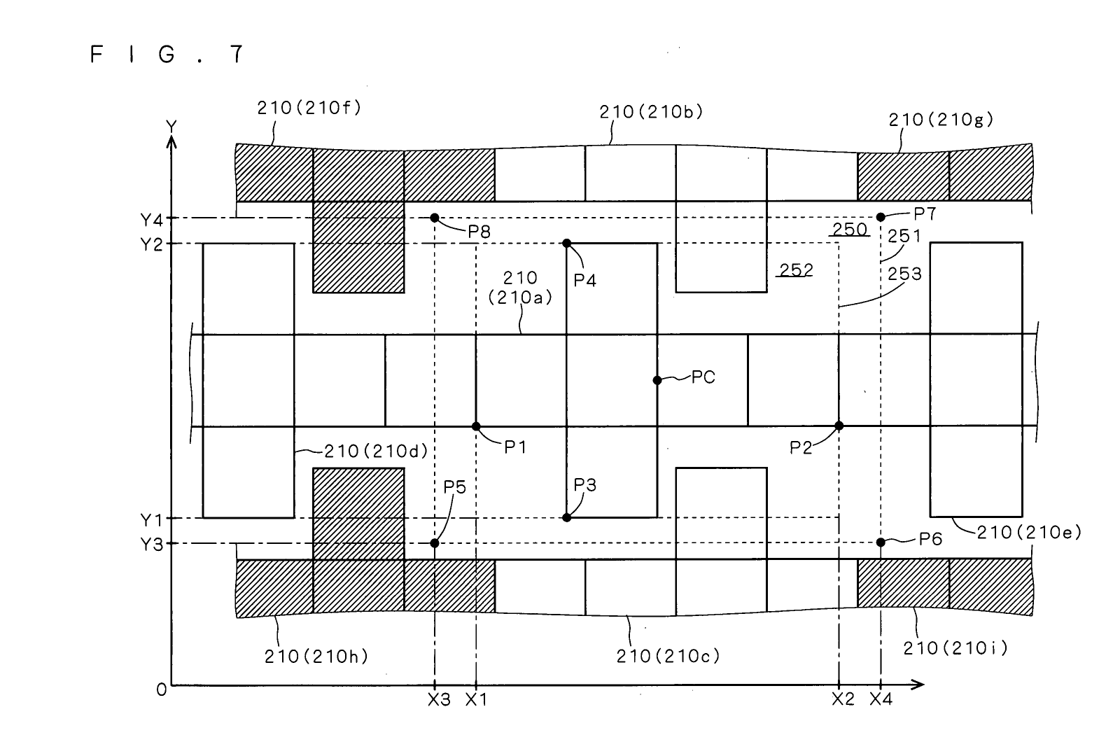

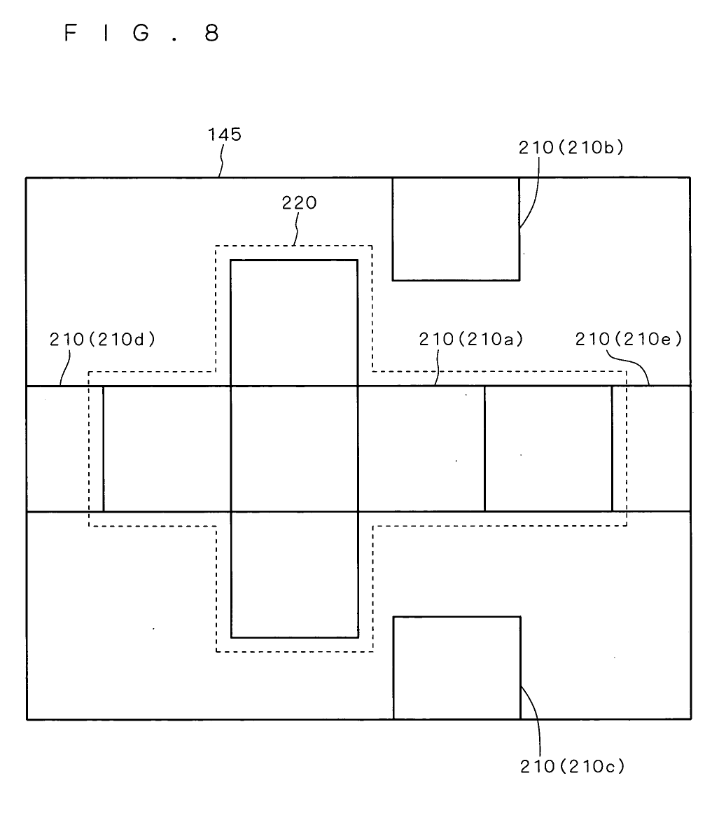

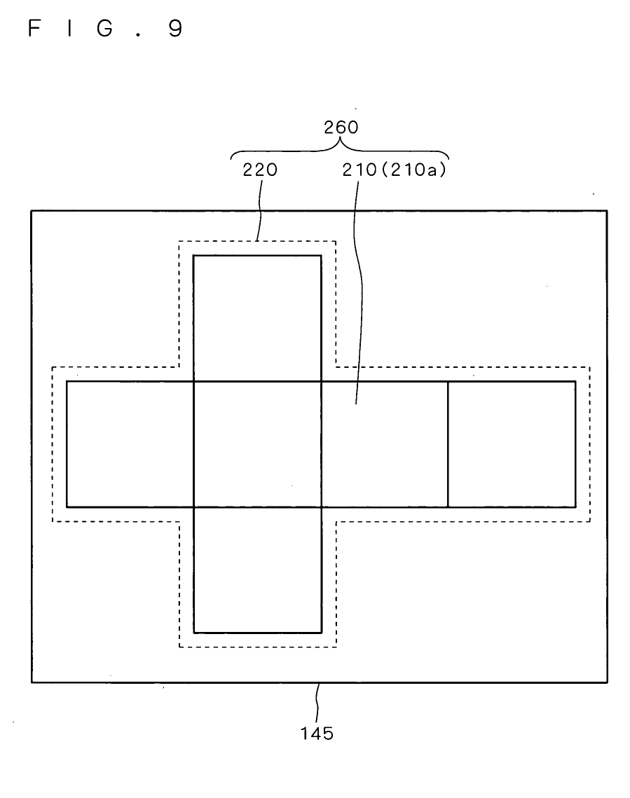

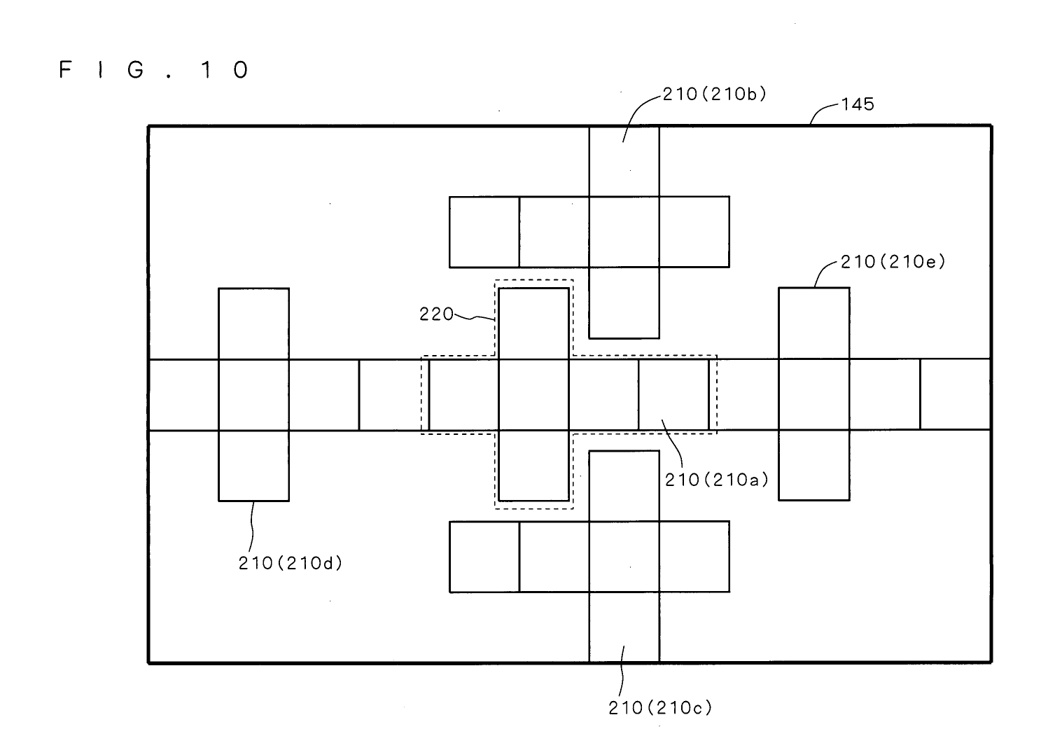

FIG. 6 shows a procedure for obtaining and displaying the adjacent graphic object when a combination of the developed drawing 210a and the mask 220 is the target graphic object. FIG. 7 illustrates an example of a method of obtaining the adjacent graphic object. FIGS. 8 and 9 show examples of the graphic objects displayed on the display screen 145 of the display device 140.

In the process of simultaneously displaying the target graphic object and the adjacent graphic object, an operator first selects the developed drawing 210a by the use of the mouse and the keyboard (not shown) of the input device 130 in an “overall display mode” in which the plurality of developed drawings 210 are displayed on the display screen 145 of the display device 140. Then, data about the selected developed drawing 210a and the corresponding mask 220 is read from the graphic data storage area 121 of the storage part 120 and stored in the target graphic object storage area 113a of the RAM 113 (in Step S101).

Next, a selection region 250 (see FIG. 7) for use in obtaining data about the adjacent graphic object adjacent to the target graphic object is set in Step S102.

Specifically, a circumscribing region 252 of a rectangular shape is set which has a boundary 253 and circumscribes the developed drawing 210a of the target graphic object. Thus, the rectangular circumscribing region 252 is set which passes through the following points P1 to P4 lying on the developed drawing 210a: the point P1 having the minimum X-coordinate X=X1, the point P2 having the maximum X-coordinate X=X2, the point P3 having the minimum Y-coordinate Y=Y1, and the point P4 having the maximum Y-coordinate Y=Y2.

Next, an outer region 250 is set which passes through points P5 (X,Y)=(X3,Y3), P6 (X,Y)=(X4,Y3), P7 (X,Y)=(X4,Y4) and P8 (X,Y)=(X3,Y4), which has a boundary 251 composed of a plurality of line segments outside the boundary 253, and which contains the circumscribing region 252.

A spread ratio RX and a spread ratio RY of the outer region 250 to the circumscribing region 252 in the X direction and in the Y direction, respectively, are defined as:

$$\begin{matrix}\begin{matrix}RX = ( X 1 - X 3 ) / ( X 2 - X 1 ) \\ = ( X 4 - X 2 ) / ( X 2 - X 1 )\end{matrix} & ( 1 ) \\ \begin{matrix}RY = ( Y 1 - Y 3 ) / ( Y 2 - Y 1 ) \\ = ( Y 4 - Y 2 ) / ( Y 2 - Y 1 )\end{matrix} & ( 2 )\end{matrix}$$

As indicated in Equation (1), the value of the spread ratio RX of a portion of the outer region 250 positioned to the right of the circumscribing region 252 is equal to that of a portion of the outer region 250 positioned to the left of the circumscribing region 252. As indicated in Equation (2), the value of the spread ratio RY of a portion of the outer region 250 positioned over the circumscribing region 252 is equal to that of a portion of the outer region 250 positioned under the circumscribing region 252. From Equations (1) and (2), it is found that the central positions of the respective outer and circumscribing regions 250 and 252 substantially coincide with each other at a point PC. Further, it is found from Equations (1), (2) and FIG. 7 that the circumscribing region 252 is contained within and surrounded by the outer region 250.

The values of the respective spread ratios RX and RY are set to satisfy Inequality (3) (preferably Inequality (4)).
0.05≦(RX, RY)≦0.30 (3)
0.10≦(RX, RY)≦0.20 (4)

Then, the outer region 250 is defined as the selection region 250 for selection of the adjacent graphic object.

Subsequently, the developed drawing 210 present in the selection region 250 set in Step S102, that is, the graphic object overlapping the selection region 250 is selected as the adjacent graphic object (in Step S103). As an example, when the developed drawing 210a shown in FIG. 7 is the target graphic object, the developed drawings 210b to 210e present in the selection region 250 are selected as the adjacent graphic objects. Thereafter, data about the selected developed drawings 210b to 210e is read from the graphic data storage area 121 and stored in the adjacent graphic object storage area 113b of the RAM 113 (in Step S104).

Next, when the display mode of the display screen 145 is changed from the “overall display mode” to an “editable mode” (in Step S105), the developed drawing 210a and the mask 220 as the target graphic object and the developed drawings 210b to 210e as the adjacent graphic objects are displayed on the display screen 145 (in Step S106; see FIG. 8).

The “editable mode” is a mode in which the adjacent graphic object is displayed, and the target graphic object is editably and correctably displayed.

This allows the operator to easily recognize whether or not the developed drawing 210a and the mask 220 displayed on the display screen 145 in Step S106 interfere with the developed drawings 210b to 210e (e.g., whether or not the inside region of the mask 220 corresponding to the developed drawing 210a contains a portion of any of the developed drawings 210b to 210e).

With both the target graphic object and the adjacent graphic object displayed on the display screen 145, the operator can perform the operation of editing the target graphic object, based on an instruction using the mouse and the keyboard (not shown) of the input device 130. This achieves the efficient operation of editing the developed drawing 210a and the mask 220, to improve the throughput of the editing operation.

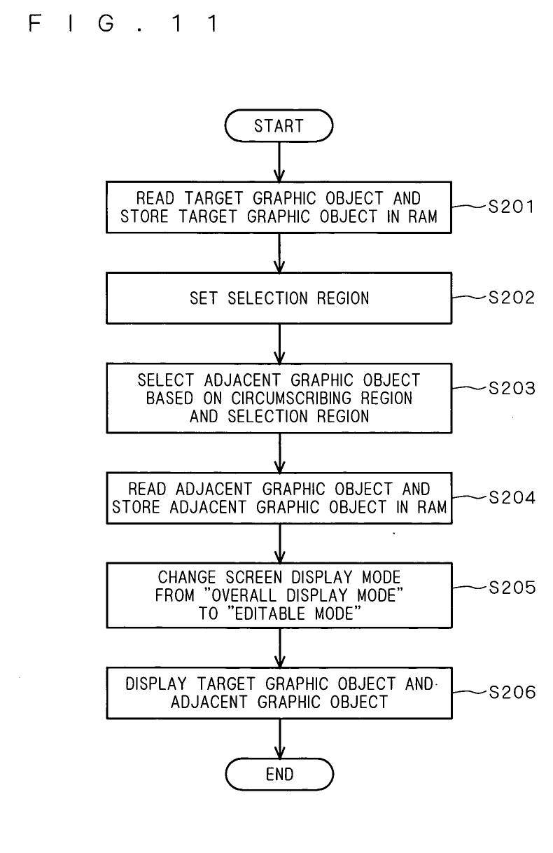

An image zoom factor is variable in the “editable mode” in this preferred embodiment. By lowering the image zoom factor below that shown in FIG. 8, the developed drawing 210a and the mask 220 as the target graphic object and the developed drawings 210b to 210e as the adjacent graphic objects are entirely displayed, as shown in FIG. 10.

### 1.4. Advantages of Graphic Processing Apparatus of First Preferred Embodiment

As described hereinabove, the graphic processing apparatus 100 according to the first preferred embodiment is capable of simultaneously displaying the target graphic object and its adjacent graphic object on the display screen 145. This enables the operator to easily recognize whether or not interference is occurring between the target and adjacent graphic objects, thereby improving the throughput of the operation of editing the target graphic object. Additionally, the first preferred embodiment facilitates the selection of the adjacent graphic object because the developed drawing 210 present in the selection region 250 is selected as the adjacent graphic object.

### 2. Second Preferred Embodiment

A second preferred embodiment according to the present invention will be described. The graphic processing apparatus of the second preferred embodiment is similar to the graphic processing apparatus of the first preferred embodiment except that there is a difference therebetween in the method of selecting the adjacent graphic object. The difference will be principally described below.

Like reference numerals and characters are used in the second preferred embodiment to designate components identical with those of the graphic processing apparatus of the first preferred embodiment. Since the components designated by like reference numerals and characters have been described in the first preferred embodiment, the description about these components will be dispensed with in the second preferred embodiment.

### 2.1. Simultaneous Display of Target Graphic Object and Adjacent Graphic Object

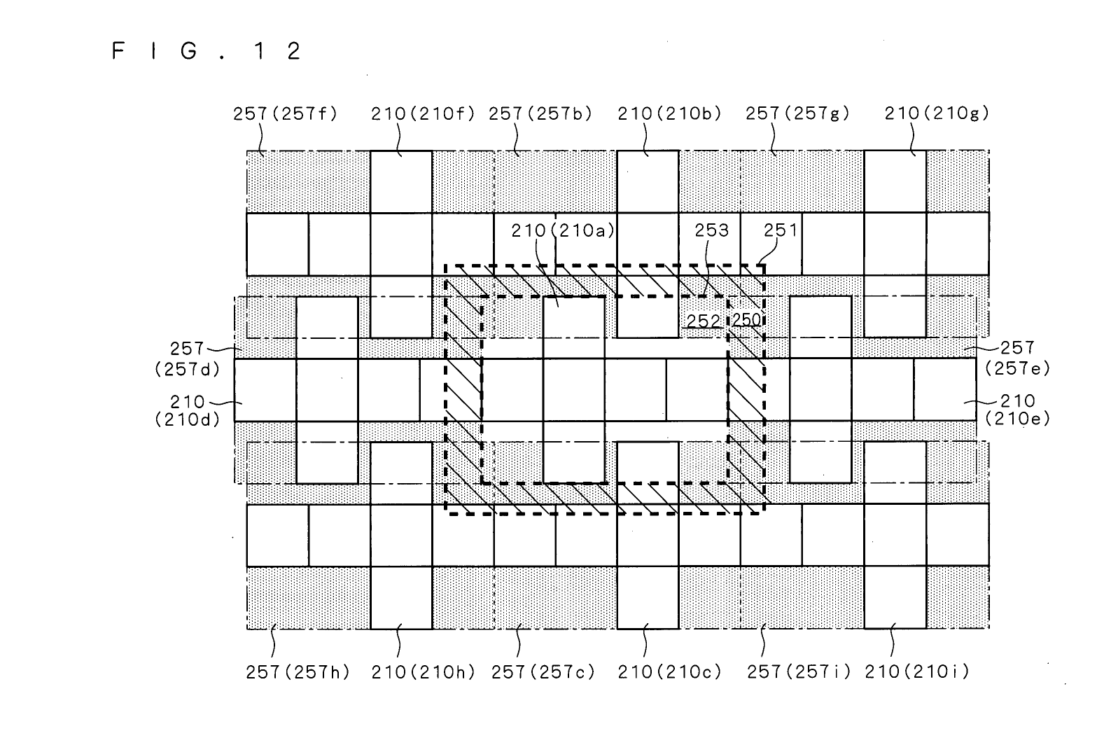

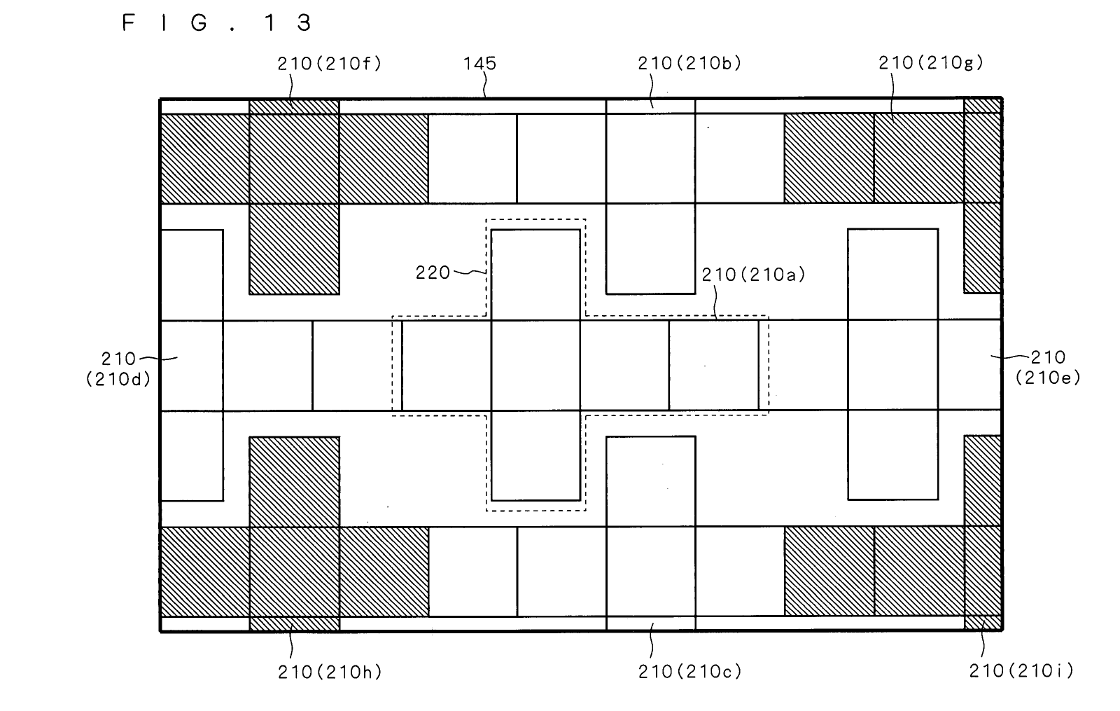

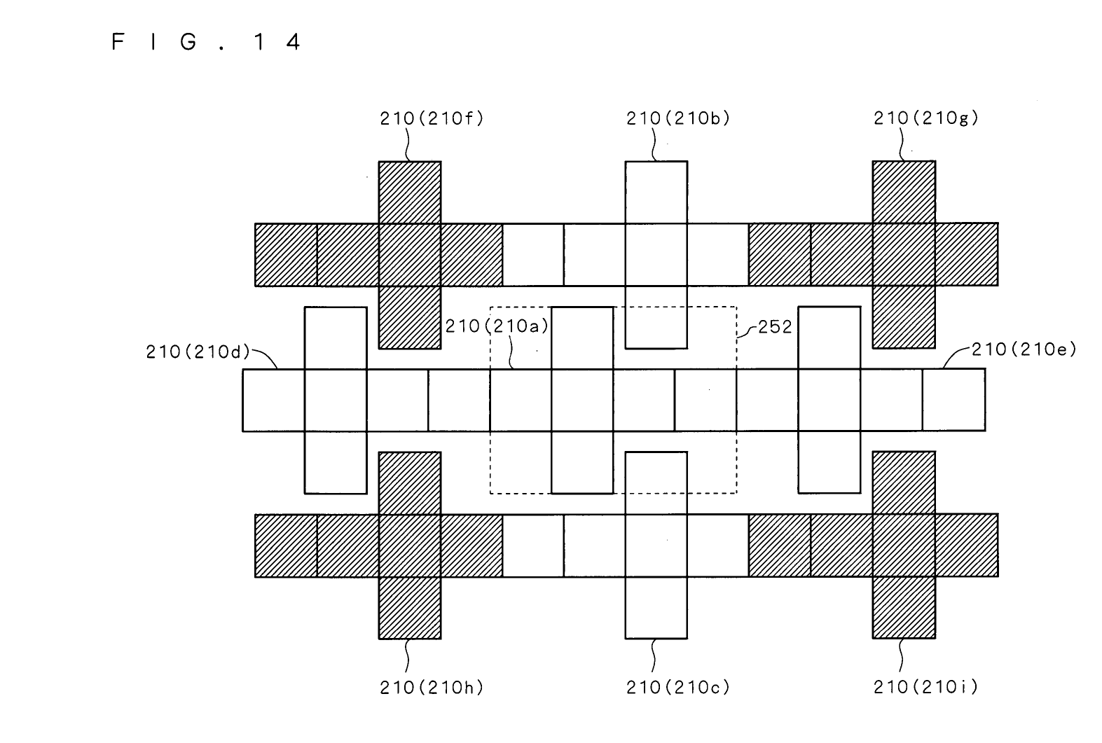

FIG. 11 shows a procedure for obtaining and displaying the adjacent graphic object when a combination of the developed drawing 210a and the mask 220 is the target graphic object. FIG. 12 illustrates an example of a method of obtaining the adjacent graphic object. FIG. 13 shows an example of the graphic objects displayed on the display screen 145 of the display device 140.

Prior to the simultaneous display process according to the second preferred embodiment, a circumscribing region 257 (257b to 257i) shown in FIG. 12 is set for each of the plurality of developed drawings 210 (see FIG. 3) contained in the CAD data 511. The circumscribing region 257 termed herein refers to an inside region surrounded by a figure of a regular shape (in this preferred embodiment, a rectangular shape) circumscribing each developed drawing 210. In other words, each developed drawing 210 contacts internally the figure of the regular shape. Information about each circumscribing region 257 (positional information about each vertex when the figure of the regular shape is rectangular) is stored in the graphic data storage area 121 of the storage part 120.

In the simultaneous display process according to the second preferred embodiment, the operator first selects the developed drawing 210a by the use of the mouse and the keyboard (not shown) of the input device 130 in the “overall display mode” in which the plurality of developed drawings 210 are displayed on the display screen 145 of the display device 140. Then, data about the selected developed drawing 210a and the corresponding mask 220 is read from the graphic data storage area 121 of the storage part 120 and stored in the target graphic object storage area 113a of the RAM 113 (in Step S201).

Next, the selection region 250 (see FIG. 12) for use in obtaining data about the adjacent graphic object is set in Step S202 in a similar manner to Step S102 (see FIG. 6) of the first preferred embodiment.

Specifically, the circumscribing region 252 of a rectangular shape is set which has the boundary 253 and circumscribes the developed drawing 210a of the target graphic object. Next, the selection region 250 is set so that the spread ratios RX and RY thereof to the circumscribing region 252 in the X and Y directions, respectively, satisfy Inequality (3) (preferably Inequality (4)).

Subsequently, a search is made for a circumscribing region 257 overlapping the selection region 250 set in Step S202, and a graphic object corresponding to the circumscribing region 257 detected as a result of the search is selected as the adjacent graphic object (in Step S203). As an example, when the developed drawing 210a shown in FIG. 12 is the target graphic object, the developed drawings 210b to 210i corresponding to the respective circumscribing regions 257b to 257i overlapping the selection region 250 are selected as the adjacent graphic objects.

Thereafter, data about the selected developed drawings 210b to 210i is read from the graphic data storage area 121 and stored in the adjacent graphic object storage area 113b of the RAM 113 (in Step S204).

Next, when the display mode of the display screen 145 is changed from the “overall display mode” to the “editable mode” (in Step S205), the developed drawing 210a and the mask 220 as the target graphic object and the developed drawings 210b to 210i as the adjacent graphic objects are displayed on the display screen 145 (in Step S206; see FIG. 13).

Thus, the execution of the simultaneous display process produces the display of the developed drawings 210b to 210i as well as the developed drawing 210a and the mask 220 on the display screen 145, as in the first preferred embodiment. This allows the operator to easily recognize whether or not the mask 220 set around the developed drawing 210a interferes with the developed drawings 210b to 210i (e.g., whether or not the inside region of the mask 220 corresponding to the developed drawing 210a contains a portion of any of the developed drawings 210b to 210i).

### 2.2. Advantages of Graphic Processing Apparatus of Second Preferred Embodiment

Like the graphic processing apparatus according to the first preferred embodiment, the graphic processing apparatus according to the second preferred embodiment is capable of simultaneously displaying the target graphic object and its adjacent graphic object on the display screen 145, as described hereinabove. This enables the operator to easily recognize whether or not interference is occurring between the target and adjacent graphic objects, thereby improving the throughput of the operation of editing the target graphic object.

Additionally, the second preferred embodiment facilitates the selection of the adjacent graphic object because the developed drawing 210 corresponding to the circumscribing region 257 present in the selection region 250 is selected as the adjacent graphic object.

### 3. Modifications

Although the first and second preferred embodiments according to the present invention have been described above, the present invention is not limited to the above-mentioned specific forms.

The developed drawing 210 present in the selection region 250 is selected as the adjacent graphic object in the first preferred embodiment. The present invention, however, is not limited to this. With reference to FIG. 14, for example, the four developed drawings 210b to 210e positioned over, under, to the left of and to the right of the circumscribing region 252 of the rectangular shape contacted internally by the developed drawing 210a, that is, lying in four positions adjacent to the circumscribing region 252 may be selected as the adjacent graphic objects.

Alternatively, the eight developed drawings 210b to 210i present around the circumscribing region 252 of the rectangular shape contacted internally by the developed drawing 210, that is, lying in eight positions adjacent to the circumscribing region 252 may be selected as the adjacent graphic objects.

The target graphic object and the adjacent graphic object may be displayed in different ways, respectively, on the display screen 145 of the first and second preferred embodiments. For example, the line segments of the target graphic object may be displayed in a different color and/or with a different thickness from those of the adjacent graphic object. This allows the operator to easily discern between the target graphic object and the adjacent graphic object, achieving the efficient operation of editing the target graphic object.

The simultaneous display process according to the first and second preferred embodiments includes simultaneously displaying the target graphic object and the adjacent graphic object after the data about the target graphic object and the data about the adjacent graphic object are obtained from the storage part 120. The present invention, however, is not limited to this. For example, Step S106 for the simultaneous display process according to the first preferred embodiment may include displaying the target graphic object (see FIG. 9), and thereafter switching between display and non-display of the adjacent graphic object, based on operator's instruction. The same modification may be made in the second preferred embodiment.

The adjacent graphic object is composed of the developed drawing 210 according to the first and second preferred embodiments, but is not limited to this. The adjacent graphic object may be composed of the developed drawing 210 and the mask 220.

While the invention has been described in detail, the foregoing description is in all aspects illustrative and not restrictive. It is understood that numerous other modifications and variations can be devised without departing from the scope of the invention.

1. A graphic processing apparatus for processing graphic information data about a plurality of graphic objects arranged within a planar area, each of said plurality of graphic objects including a graphic portion composed of a plurality of graphic primitives, said graphic processing apparatus comprising:
(a) a first obtaining element for obtaining a target graphic object selected from among said plurality of graphic objects;
(b) a second obtaining element for obtaining an adjacent graphic object positioned adjacent to said target graphic object;
(c) a display element for displaying said target graphic object together with said adjacent graphic object while maintaining a positional relationship between said target graphic object and said adjacent graphic object, based on said target graphic object; and
(d) an editing element for editing said target graphic object, based on an instruction given by an operator, with both said target graphic object and said adjacent graphic object displayed on said display element.

2. The graphic processing apparatus according to claim 1, wherein
said editing element includes
an element for correcting the planar area of a mask portion, said mask portion being formed as an expanded area of the graphic portion of said target graphic object, said mask portion defining an area where design data is put on said target graphic object.

3. The graphic processing apparatus according to claim 2, wherein
said second obtaining element sets a first figure of a regular shape, based on a second figure of a regular shape surrounding said target graphic object, to select a graphic object overlapping said first figure among said plurality of graphic objects as said adjacent graphic object.

4. The graphic processing apparatus according to claim 2, wherein
said second obtaining element sets a first figure of a regular shape, based on a second figure of a regular shape surrounding said target graphic object, and sets a circumscribing region surrounded by a third figure of a regular shape for each of said plurality of graphic objects, to select a graphic object corresponding to said circumscribing region overlapping said first figure as said adjacent graphic object.

5. The graphic processing apparatus according to claim 4, wherein
the regular shape of said third figure is a first rectangle contacted internally by each of said plurality of graphic objects.

6. The graphic processing apparatus according to claim 5, wherein
the regular shape of said second figure is a second rectangle contacted internally by said target graphic object, and
the regular shape of said first figure is a third rectangle surrounding said first rectangle.

7. The graphic processing apparatus according to claim 6, wherein
the central position of said second rectangle substantially coincides with the central position of said third rectangle.

8. The graphic processing apparatus according to claim 1, wherein
said second obtaining element selects as said adjacent graphic object a graphic object lying in each of four positions adjacent to a rectangle contacted internally by the graphic portion of said target graphic object among said plurality of graphic objects.

9. The graphic processing apparatus according to claim 1, wherein
said second obtaining element selects as said adjacent graphic object a graphic object lying in each of eight positions adjacent to a rectangle contacted internally by the graphic portion of said target graphic object among said plurality of graphic objects.

10. The graphic processing apparatus according to claim 1, wherein
said display element displays said target graphic object in a different way from said adjacent graphic object.

11. The graphic processing apparatus according to claim 10, wherein
said display element displays said target graphic object in a different color from said adjacent graphic object.

12. The graphic processing apparatus according to claim 11, wherein
said display element displays line segments constituting said target graphic object with a different thickness from line segments constituting said adjacent graphic object.

13. A method of performing a graphic process on graphic information data about a plurality of graphic objects arranged within a planar area, each of said plurality of graphic objects including a graphic portion composed of a plurality of graphic primitives, said method comprising the steps of:
(a) obtaining a target graphic object selected from among said plurality of graphic objects;
(b) obtaining an adjacent graphic object positioned adjacent to said target graphic object;
(c) displaying said target graphic object together with said adjacent graphic object while maintaining a positional relationship between said target graphic object and said adjacent graphic object, based on said target graphic object; and
(d) editing said target graphic object,
wherein said step (d) includes the step of editing said target graphic object, based on an instruction given by an operator, with both said target graphic object and said adjacent graphic object displayed on a display element.

14. A computer-readable program for processing graphic information data about a plurality of graphic objects arranged within a planar area, each of said plurality of graphic objects including a graphic portion composed of a plurality of graphic primitives, said program causing a computer to perform the steps of:
(a) inputting a target graphic object selected from among said plurality of graphic objects to store said target graphic object in a storage element of said computer;
(b) inputting an adjacent graphic object positioned adjacent to said target graphic object to store said adjacent graphic object in said storage element of said computer;
(c) displaying said target graphic object together with said adjacent graphic object on a display element while maintaining a positional relationship between said target graphic object and said adjacent graphic object, based on said target graphic object by a computation element of said computer; and
(d) editing said target graphic object stored in said storage element in response to a manipulation of an operator,
wherein said step (d) includes the step of editing said target graphic object based on an instruction given by the operator, with both said target graphic object and said adjacent graphic object displayed on said display element.
